(19) United States
(12) Patent Application Publication
(10) Pub. No.: US 2012/0199788 A1
(43) Pub. Date: Aug. 9, 2012

(54) Crosslinking Initiator

(75) Inventors: Tamizio Guidi, Seraing (BE); Olivier Roumache, Huy (BE); Jean-Louis Joseph Brasseur, Flemalle (BE)

(73) Assignee: SOCIETE INDUSTRIELLE LIEGEOISE DES OXYDES SA, Engis (BE)

(21) Appl. No.: 13/502,017

(22) PCT Filed: Oct. 15, 2010
(86) PCT No.: PCT/EP10/65499

§ 371 Date: Apr. 13, 2012

(30) Foreign Application Priority Data
Oct. 15, 2009 (BE) 2009/0629

(51) Int. Cl. C09K 3/00; B82Y 40/00; B82Y 30/00

(52) U.S. Cl. 252/182.33; 977/762; 977/890

(57) ABSTRACT

The invention relates to a crosslinking initiator including a mineral filler and a zinc compound grafted on to said mineral filler, where said zinc compound is chosen from the group consisting of zinc oxide, zinc hydroxide and the mixtures thereof, the zinc compound being in the form of individual rod-like particles of nanometric size, and the mineral filler being in the form of grains having a particle size larger than that of the zinc compound and where the individual particles of the zinc compound are grafted on to the surface of the grains of the mineral filler in a uniformly dispersed manner.

The present invention relates to a crosslinking initiator, in particular for vulcanization, and to its manufacturing method.

In conventional rubber formulations, zinc oxide is traditionally used as an activator for initiating the vulcanization process. However, it is found that zinc oxide only reacts at the surface and therefore that a significant percentage of zinc oxide is not active.

Strongly decreasing the size of the particles is not a solution. Indeed, in this case, good dispersion of the particles in the matrix is no longer ensured.

Consequently, in the field of rubber, the preparation of mineral fillers coated with a fine continuous zinc oxide layer was devised a certain number of times. As an example, document WO 2007/041060 describes particles coated with zinc oxide or zinc carbonate which may be used in diverse applications such as for example, cosmetics, rubber, polymeric materials and similar substances. As another example of a document describing such particles, mention may be made of patent application U.S. 2007/0072959.

In certain cases, physically mixing zinc oxide with a mineral filler was also devised for facilitating dispersion of zinc oxide in rubber formulations. However, it appears that the product resulting from such a mixture is generally not very efficient.

Also a method for precipitating a water-soluble zinc salt on calcium carbonate grains is also known, followed by energy-intensive calcination, where granulation is poorly controlled (JP 60264324).

Finally complex methods are known for grafting zinc oxide on filler grains coated beforehand with a layer of another material (U.S. Pat. No. 5,846,310 and U.S. 2008/0193760).

The object of the invention is to avoid the drawbacks of the present technique and to develop a particularly active crosslinking initiator and the dispersion of which in the medium is ensured in a particularly efficient way.

The object thereof is also the development of a method allowing simple and efficient making of this initiator, which, advantageously, simultaneously reduces the problems of energy consumption and of atmospheric pollution generally exhibited by the prior techniques.

For this purpose, according to the invention, provision is made for a crosslinking initiator comprising a mineral filler and a zinc-bearing compound grafted on this mineral filler, in which said zinc-bearing compound is selected from the group consisting of zinc oxide, zinc hydroxide and mixtures thereof, the zinc-bearing compound being in the form of individual particles as rods with nanometric size and the mineral filler in the form of grains having a grain size greater than that of the zinc-bearing compound and in which the individual particles of the zinc-bearing compound are grafted in a uniformly dispersed manner on the surface of said grains of the mineral filler.

Thus, this grafting of nanometric particles on the mineral filler grains clearly improves the accessibility of the medium to the zinc-bearing compound as compared with a continuous coating of this compound on the same particles. Therefore, less of it should be used in rubber formulations. The losses during the manufacturing process are consequently considerably reduced.

Further, the agent according to the invention is grafted in a very simple way directly on the surface of the mineral filler grains, without requiring prior coating or impregnation of the grains with a precursor or another material.

Advantageously, according to the invention, the zinc-bearing compound is selected from the group consisting of zinc oxide, of zinc hydroxide and mixtures thereof, which gives the possibility of avoiding any subsequent calcination operation during their manufacturing.

In the sense of the invention, the term of “rubber” used as such or in an expression “the rubber industry” refers to any natural, synthetic rubber and to other polymers which may be crosslinked, in particular vulcanized by or with an initiator, such as for example zinc oxide.

In a preferential embodiment, the mineral filler is selected from the group consisting of calcium carbonate, kaolin, silica, clay, talcum, mica and carbon black. Any other mineral filler traditionally used by the rubber industry may be contemplated.

In the crosslinking initiator according to the invention, the mineral filler is preferably calcium carbonate or kaolin, since both of these compounds are already used in rubber-based formulations and the use of the initiator according to the invention therefore does not add any new elements into the formulation.

Preferably, the zinc-bearing compound is in the form of individual particles in the form of rods, the dimensions of which are comprised between one micron and one nanometer. In this way, zinc oxide for example is made more available for its use during vulcanization of the rubber, a significant reduction in the zinc oxide incorporation level may be contemplated according to the invention. Vulcanization comparable to the reference mixtures is possible in spite of a reduction by 40 to 70% by weight of the zinc oxide content (i.e. for example a reduction by 5 or 2.5 phr used with the present products at 1.5 phr as advantageously provided with the initiator according to the invention (parts per 100 parts of rubber)).

Preferentially, the grafted zinc-bearing compound has an incorporation level comprised between 1 and 50% by weight based on the total weight of the crosslinking initiator, preferably between 17 and 30% and more preferentially between 20 and 25%.

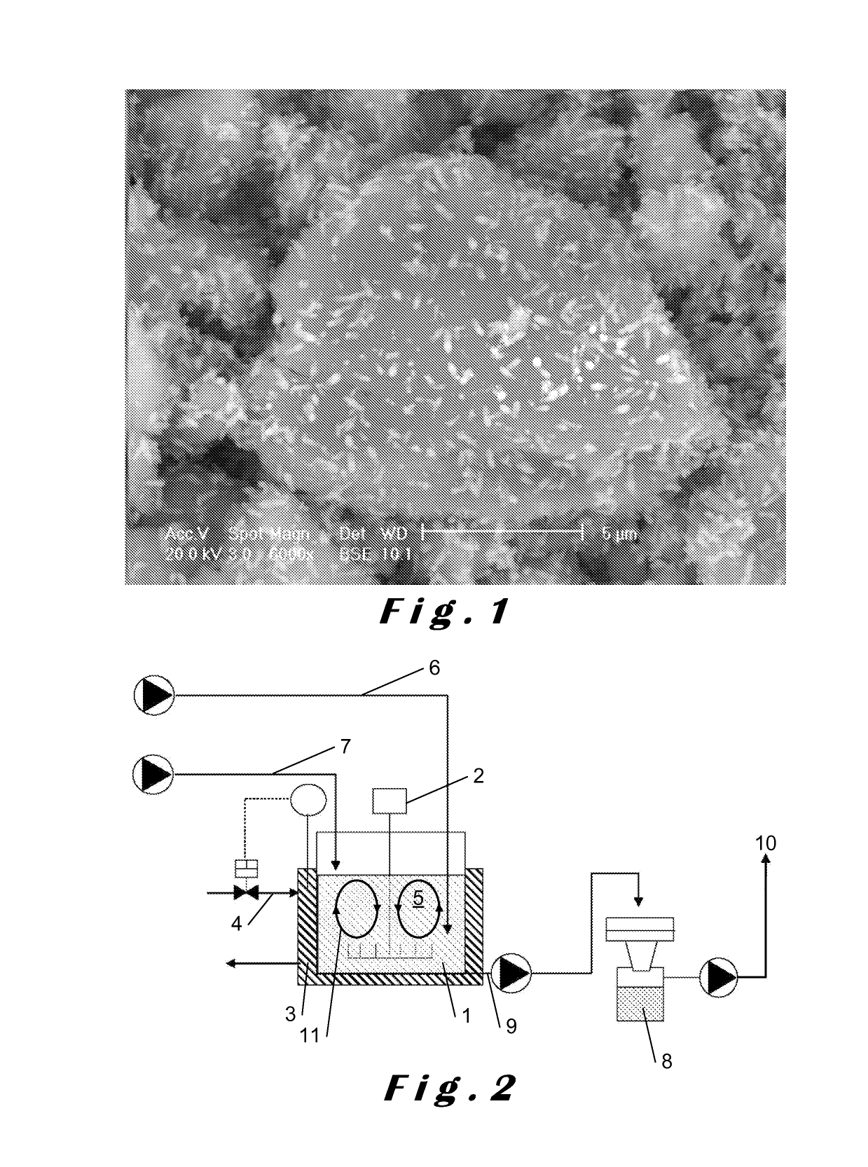

From this, it is clearly apparent that the grafted zinc-bearing compound does not provide what is commonly called a coating. indeed, as this may be seen in FIG. 1, the mineral filler in the form of grains, forms the core of the particles of the initiator according to the invention and the zinc-bearing compounds, present at its surface as rods, are grafted into a structure which may be described as being “like an urchin”. The grains of the mineral filler have a grain size greater than that of the zinc-bearing compound. The rods of the zinc-bearing compound are dispersed more or less homogeneously at the surface of the mineral filler grains but do not cover the entirety of the latter which improves accessibility to the zinc-bearing compound.

Other embodiments of the crosslinking initiator according to the invention are indicated in the appended claims.

The object of the invention is also a method for manufacturing a crosslinking initiator according to the invention comprising:
dispersing with stirring a mineral filler in an aqueous phase at a pre-determined temperature, with formation of an aqueous suspension,
circulating this aqueous suspension along a controlled circuit,
introducing into the aqueous suspension an aqueous solution of a base at a first end of said circuit,
feeding, simultaneously with said introduction, an aqueous solution of a zinc salt to said aqueous suspension, at a second end of the circuit opposite to said first end,

and
precipitating a zinc-bearing compound selected from the group consisting of zinc oxide, zinc hydroxide and mixtures thereof, which is grafted in a uniformly dispersed way at the surface of said suspended mineral filler, the zinc-bearing compound being in the form of individual particles as rods with nanometric size and the mineral filler in the form of grains having a grain size greater than that of the zinc-bearing compound.

Surprisingly it appeared that with this method, notable improvement in the precipitation of the zinc-bearing compound on the mineral filler grains and not beside the latter was obtained.

Indeed, the stirring obtained by circulating the aqueous suspension ensures perfect and homogeneous dispersion of the mineral filler grains in the whole reaction volume, the substrate thereby ideally playing its role of germination nucleus.

In order that the precipitated zinc-bearing compound with nanometric size be distributed as uniformly as possible on the substrate, it is important that the precipitation conditions be perfectly under control. It is advantageous if the concentrations both for the substrate and for the two simultaneously added reagents be practically constant in the whole volume of the reactor without there appearing local oversaturation. This is achieved according to the invention by circulating the reaction medium along a controlled circuit notably by studying the speeds of rotation of the stirrers used and the flows generated by the latter as well as the relative positioning of the admissions of both reagents.

Indeed, it appeared surprisingly that both of the introduced substances, the base solution and the zinc salt solution, have to be introduced into the suspension of mineral filler grains in positions as most opposite as possible. In this way, both solutions are well diluted in the bulk of the suspended medium before they are encountered by the circulation of the aqueous suspension.

The method according to the invention therefore advantageously comprises in the circulated aqueous suspension, dilution of the introduced aqueous base solution and dilution of the supplied aqueous zinc salt solution before a reaction between the base and the zinc salt which will give rise to said precipitation step of a zinc-bearing compound.

With this strict control of the operating conditions, while avoiding too high local oversaturations, it is possible to minimize the losses of the zinc-bearing compound by precipitation exteriorly to the surface of the mineral filler grains.

As this may be seen from the foregoing, the method according to the invention is easily applied, since essentially it only requires a stirred reactor, possibly heated to a low temperature, but especially, as compared with manufacturing methods which decompose zinc carbonate (such as for example the method described in document WO2007/041060), it does not require any calcination step which considerably reduces the environmental impact (reduction of the energy consumption, CO₂ evolvement).

For the precipitation step, the base is advantageously selected from the group consisting of a basic hydroxide, preferably NaOH or KOH, and of a zincate, preferably sodium zincate, and mixtures thereof.

The zinc salt may be selected from the group consisting of a zinc chloride, nitrate and sulfate, preferably zinc sulfate.

In an advantageous embodiment of the method, the zinc-bearing compound is selected from the group consisting of zinc oxide, zinc hydroxide and mixtures thereof.

Preferably, in the sense of the invention, the mineral filler is selected from the group consisting of calcium carbonate, kaolin, silica, clay, talcum, mica and carbon black and of any other mineral or organic filler traditionally used by the rubber industry which preferentially uses calcium carbonate or kaolin.

In a preferential embodiment, the predetermined temperature is located between room temperature and 95° C. and preferably between 40 and 60° C., advantageously around 50° C.

This actually represents the temperature at which the neutralization reaction between the zinc sulfate and the base has an optimum yield.

Advantageously, the method according to the invention occurs at a pH from 8 to 11.

In a preferential embodiment of the method according to the invention, after precipitation of the zinc-bearing compound on the suspended mineral filler in the aqueous phase, the thereby grafted product is recovered by filtration.

This filtration is optionally followed by washing with water and/or by drying.

During the simultaneous addition of zinc sulfate and of a base to the aqueous suspension of the mineral filler, an increase in the stirring rate may be required.

This increase in the stirring rate during the neutralization reaction allows the reaction medium to be homogenized which promotes the formation of nanometric rods of the zinc-bearing compound.

According to a preferred embodiment of the invention, the dispersion occurs in a reactor where circulation is accomplished along a circuit between the surface of the suspension and the bottom of the reactor, said step for introducing the base occurring at the surface of the suspension and said step for supplying the zinc salt solution to the bottom of the reactor or, conversely, said step for introducing the base occurring at the bottom of the reactor and said step for supplying the zinc salt solution at the surface of the suspension.

According to another embodiment of the invention, the dispersion occurs in a reactor where circulation is accomplished along a circuit arranged horizontally or obliquely between both of its ends.

Other embodiments of the method according to the invention are indicated in the appended claims.

The invention also relates to the use of the initiator according to the invention in a method for crosslinking materials such as rubber, cosmetics, polymers and similar substances. It may most particularly be applied in a vulcanization method.

Other features, details and advantages of the invention will become apparent from the description given hereafter, not as a limitation and referring to the appended examples and figures.

FIG. 1 is an electron microscopy photograph of a sample of the crosslinking initiator according to the invention.

FIG. 2 is a schematic illustration of the method according to the invention.

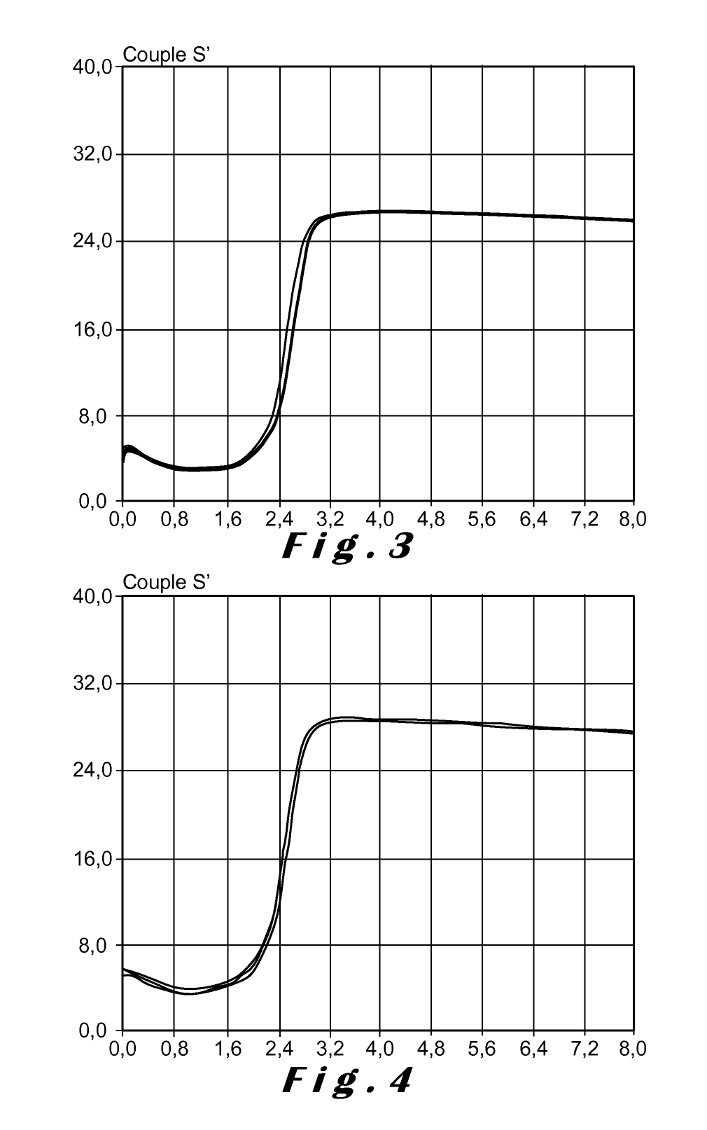

FIG. 3 represents the vulcanization curves at 170° C. obtained from free zinc oxide in an amount of 5 parts for 100 parts (5 phr) in a rubber formulation.

FIG. 4 illustrates the vulcanization curves at 170° C. obtained from zinc oxide grafted on calcium carbonate in an amount of 5 parts for 100 parts, in a rubber formulation.

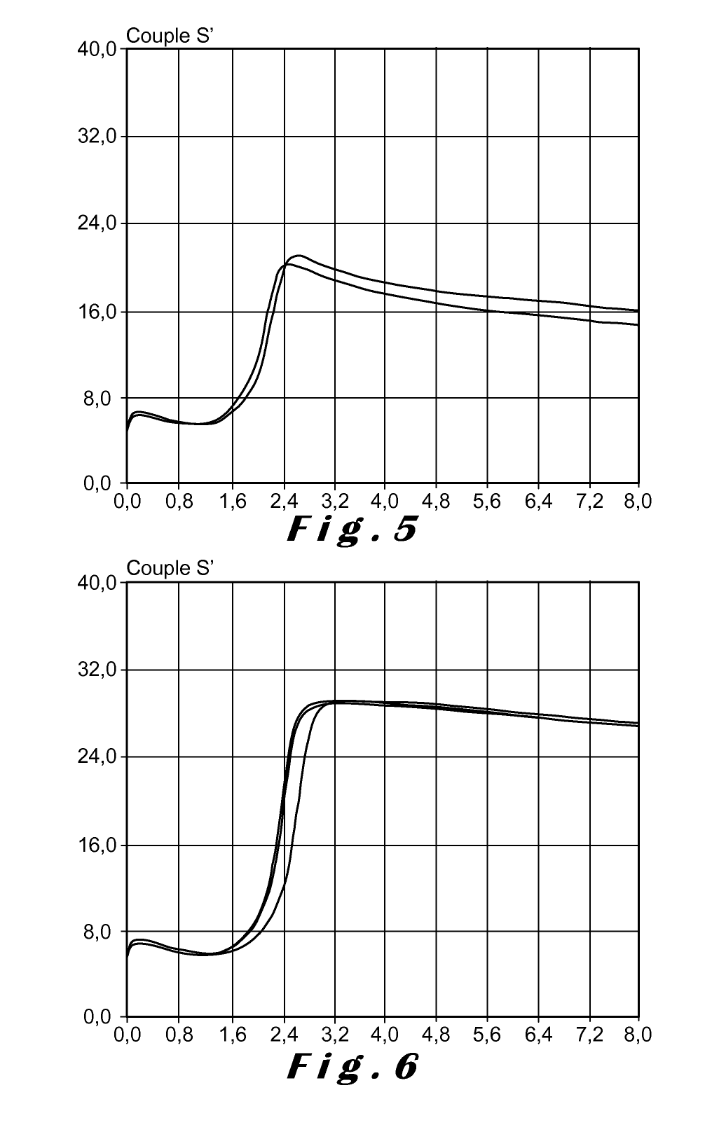

FIG. 5 illustrates the vulcanization curves at 170° C. obtained from free zinc oxide in an amount of 1.5 parts for 100 parts, in a rubber formulation.

FIG. 6 illustrates the vulcanization curves at 170° C. obtained from zinc oxide grafted on calcium carbonate in an amount of 1.5 parts for 100 parts, in a rubber formulation.

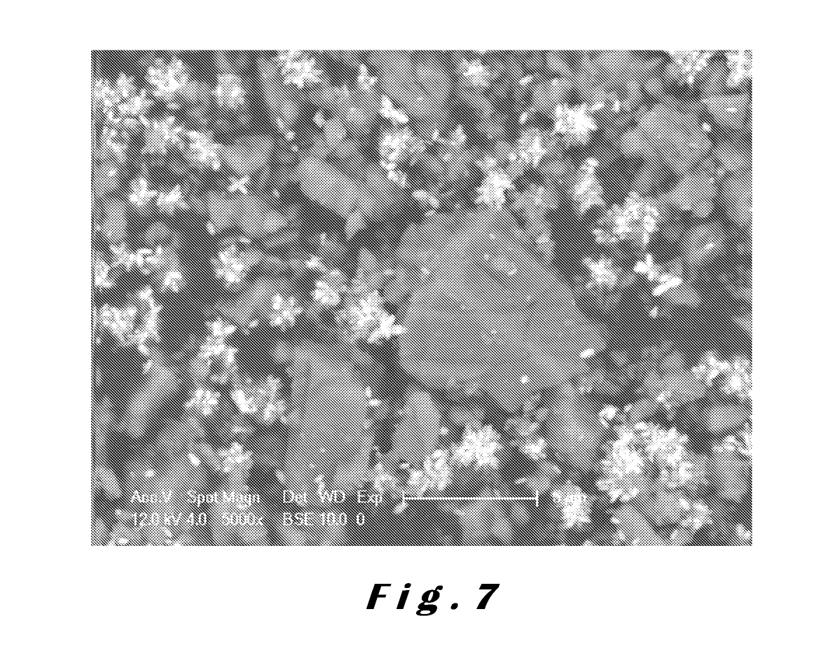

FIG. 7 is an electron microscopy photograph of a sample of an initiator obtained under the conditions of the comparative example 3.

As this may be seen in FIG. 1, the crosslinking initiator according to the invention comprises a mineral filler onto which a zinc-bearing compound is grafted. In this illustrated embodiment, the mineral filler is calcium carbonate, also called calcite, on which zinc oxide is in majority grafted. As this maybe seen, the grain size range of the calcite extends from 0.1 micron to 15 microns. The shape of the calcite grains is roughly rhombohedral with a very large majority of shapeless fractured grains. The much narrower, grain size range of the grafted zinc oxide particles, extends from 100 to 500 nanometers. The individual zinc oxide particles have a characteristic rod-shape and are homogeneously dispersed at the surface of the calcite grains but do not cover the entirety of the surface of the latter.

The detection of the ZnO grains by contrast on the CaCO₃ background was carried out by examining back-scattered electrons. While with the conventional examination of secondary electrons, it is possible to have a good observation of the morphology by enhancing the relief, the examination of back-scattered electrons allows differentiation depending on the chemical nature of the observed materials. Heavy atomic nuclei are more active in back-scattering than light atomic nuclei. Consequently, the zinc-bearing compounds appear white on a darker CaCO₃ background.

As this was stated earlier, the method according to the invention consists of neutralizing a zinc sulfate solution with a basic solution or a base in the presence of a mineral filler so that the entirety of the formed zinc-bearing compound, for example zinc oxide, is deposited on the latter.

As this may be seen in FIG. 2, the methods for manufacturing a compound according to the invention comprises a first step for dispersing with stirring a mineral filler in an aqueous phase at a predetermined temperature in a reactor 1, for example provided with a variable speed stirrer, in particular a turbine 2. Preferably, the reactor 1 is provided with a heating jacket 3 allowing the predetermined temperature to be maintained. The predetermined temperature is preferably located around 50° C. and is controlled via a circuit for circulating heating water 4 in the jacket 3. The reactor 1 therefore contains an aqueous phase 5 in which a mineral filler, preferably calcium carbonate or kaolin, is dispersed with stirring, forming an aqueous suspension.

The method illustrated in FIG. 2 comprises simultaneous addition to the aqueous suspension, of a zinc sulfate solution and of a base, for example a zincate which has a basic hydroxide content. The zinc sulfate solution is supplied into the reactor through a dip tube 6 not very far from the blades of the turbine. Moreover, the zincate, preferably sodium zincate is supplied at the surface of the suspension by a feeder 7. The supply of the two reagents is thus accomplished at the opposite ends of the circulation circuit 11 which the turbine causes the suspension to follow.

After having brought the stirring rate to the desired level, greater than that of the dispersion step, both of the reagents are supplied at room temperature. In order to homogeneously maintain the pH at about 9 in the whole suspension, the zinc sulfate is preferably injected at a constant flow rate by means of the dip tube 6 located above the stirrer which ensures downward central circulation while the zincate is supplied at a controlled flow rate at the surface of the suspension.

Under these conditions, the neutralization reaction leads to the precipitation of a zinc-bearing compound, in particular nanometric zinc oxide and/or hydroxide, on the mineral filler and gives the possibility of obtaining the crosslinking initiator according to the invention. This precipitation method clearly improves the yield of the zinc-bearing compound deposit on the substrate grains. Once the precipitation of zinc oxide and/or hydroxide is achieved on said mineral filler, the latter is recovered, preferably by filtration.

In the laboratory, filtration is for example accomplished on a Büchner filter 8 which is fed with the suspension drawn off at the outlet 9, the Büchner filter being connected to a vacuum source 10.

### EXAMPLE 1

In a stirred 4 L, tank, 400 g of micronized calcium carbonate (having a d₅₀ of 2 μm) in 1,600 g of demineralized water were dispersed by means of a turbine rotating at a speed of 600 revolutions per minute.

The suspension was heated to 50° C. and this temperature was maintained throughout the reaction.

The stirring rate was then set to 1,400 revolutions per minute and a purified zinc sulfate solution with a zinc titer of 167 g per liter and a sodium zincate solution with a zinc titer of 40 g per liter and with an NaOH titer of 300 g per liter, both at room temperature, were supplied simultaneously. The zinc sulfate supply flow rate is 7.5 mL per minute and that of sodium zincate of 5.2 mL per minute. The zinc sulfate is injected at a constant flow rate above the turbine while the zincate is supplied at the surface of the suspension. The flow rates mentioned above are controlled so as to maintain the pH of the suspension at 9. Neutralization was carried out for a period of an hour and the suspension was then filtered on a 5 dm² Büchner filter. The thereby recovered solid phase was washed with demineralized water until a conductivity of 1 mS/cm was obtained and the cake was dried at 105° C. in a pulsed air oven.

The obtained cake had a thickness of 12 mm and a humidity of 40.3%. The dried cake was then milled in a pin mill. The obtained product was then analyzed and the results are illustrated in Table 1.

TABLE 1

| | |
|---|---|
| Grain size D₅₀ (microns) | 2.94 |
| Grain size D₉₉ (microns) | 17.8 |
| Oil absorption (g per 100 g) | 48.9 |
| Loss at 105° C. (%) | 0.05 |
| Loss at 400° C. (%) | 0.46 |
| Loss at 800° C. (%) | 32.4 |
| ZnO (%) | 21.5 |
| Ca (%) | 31.0 |
| CO₂ (%) | 35.5 |
| Mg (ppm) | 1010 |
| Fe (ppm) | 104 |
| Cl (ppm) | <8 |
| BET (m² per g) | 4.5 |

FIGS. 3 to 6 were obtained on a Montech MDR3000 rheometer at a temperature of 170° C. These vulcanization curves show to anyone skilled in the art the equivalence of both types of oxide for vulcanization and therefore the possibility of reducing the zinc content in the formulations.

Indeed, observation of FIGS. 3 to 6 confirms that the product according to the invention in customary concentrations allows vulcanization with a quality equal to that obtained with conventional zinc oxide.

Further, the product according to the invention allows vulcanization at a much lower zinc concentration than the usual doses, which confirms that the availability of zinc oxide has been increased and consequently the incorporation level may be reduced significantly.

### EXAMPLE 2

The test was carried out in a jacketed 500 L tank, equipped with two types of stirrers, a turbine excentered by a quarter of the diameter and a paster with a wall scraper.

By means of the paster rotating at a speed of 50 revolutions per minute, 25 kg of micronized calcium carbonate (having a d₅₀ of 2 μm) in 210 L of demineralized water were dispersed.

The suspension is heated to 50° C. by controlling circulation of steam in the jacket and this temperature was maintained throughout the reaction.

When the temperature is attained, the turbine is started at 2,780 revolutions per minute, the paster is stopped and a solution of zinc sulfate at 160 g per liter and a solution of NaOH at 251 g per liter, both at room temperature, are supplied simultaneously.

The supply flow rate of the zinc sulfate is 0.82 L per minute and that of the NaOH solution of 0.62 L on average per minute.

The zinc sulfate is injected at constant flow rate by means an immersion tube 10 cm above the turbine while the NaOH is supplied to the surface of the suspension. The NaOH flow rate is controlled so as to maintain the pH of the suspension at 9. Neutralization was accomplished for a period of 152 minutes. The suspension is then filtered on a 1.7 m² filter press, the cake is then washed with demineralized water until a conductivity of 1.8 mS/cm is obtained. The obtained cake had a thickness of 38 mm and a humidity of 36.28%.

The cake is then dried in a dryer of the Spin-Flash type in order to obtain a loss at 105° C. of less than 0.1%.

The product was then analyzed and the results are illustrated in Table 2 below.

TABLE 2

| | |
|---|---|
| Grain size D₅₀ (microns) | 2.88 |
| Grain size D₉₉ (microns) | 17.4 |
| Oil absorption (g per 100 g) | 45.9 |
| Loss at 105° C. (%) | 0.09 |
| Loss at 400° C. (%) | 0.68 |
| Loss at 800° C. (%) | 22.4 |
| ZnO (%) | 48.8 |
| Ca (%) | 19.0 |
| CO₂ (%) | 22.2 |
| Mg (ppm) | 1010 |
| Fe (ppm) | 101 |
| Cl (ppm) | 34 |
| BET (m² per g) | 4.1 |

### EXAMPLE 3

### Comparative Example

In a 4 L stirred tank, 400 g of micronized calcium carbonate (having a d₅₀ of 2 μm) in 1,600 g of demineralized water were dispersed by means of a turbine rotating at a speed of 600 revolutions per minute.

The suspension was heated to 50° C. and this temperature was maintained throughout the reaction.

The stirring rate was then brought to 1,400 revolutions per minute and a solution of purified zinc sulfate with a zinc titer of 167 g per liter and a solution of sodium zincate with a zinc titer of 50 g per liter and with a NaOH titer of 300 g per liter, both at room temperature, were supplied to the surface of the suspension simultaneously. The supply flow rate of zinc sulfate is 7.50 mL per minute and that of sodium zincate is 5.20 mL per minute. The flow rates mentioned above are controlled so as to maintain the pH of the suspension at 9. Neutralization was accomplished for a period of one hour and the suspension is then filtered on a 5 dm² Büchner filter. The thereby recovered solid face was washed with demineralized water until a conductivity of 1 mS/cm is obtained. The obtained cake had a thickness of 11 mm and a humidity of 43.2%.

The cake was dried at 105° C. in a pulsed air oven and then milled in a pin mill.

The obtained product was then analyzed and the results are illustrated in Table 3 below.

TABLE 3

| | |
|---|---|
| Grain size D₅₀ (microns) | 3.30 |
| Grain size D₉₉ (microns) | 19.95 |
| Oil absorption (gram per 100 g) | 39.7 |
| Loss at 105° C. (%) | 0.15 |
| Loss at 400° C. (%) | 0.53 |
| Loss at 800° C. (%) | 20.6 |
| ZnO (%) | 19.7 |
| Ca (%) | 29.9 |
| CO₂ (%) | 35.7 |
| Mg (ppm) | 1120 |
| Fe (ppm) | 134 |
| Cl (ppm) | 13 |
| BET (m2 per g) | 2.8 |

SEM analysis illustrated by the micrograph of FIG. 7 shows surprisingly how the microstructure of the obtained product is different from the one obtained according to the invention and illustrated by the micrograph of FIG. 1.

It is seen that the ZnO particles are agglomerated in “small bouquets of rice grains”, without any apparent interaction with the large substrate particles. This actually contrasts with the situation according to the invention where the ZnO particles are grafted and dispersed homogeneously on the surface of the substrate grains and therefore clearly more available during vulcanization.

The result of the test of Example 3 is considered as negative.

### EXAMPLE 4

In a stirred 4 L tank, 400 g of micronized kaolin (having a d₅₀ of 2.5 μm) in 1,600 g of demineralized water were dispersed by means of a turbine rotating at a speed of 600 revolutions per minute.

The suspension was heated to 50° C. and this temperature was maintained throughout the reaction.

The stirring rate was then set to 1,400 revolutions per minute and a purified zinc sulfate solution with a zinc titer of 167 g per liter and a sodium zincate solution with a zinc titer of 40 g per liter and with a NaOH titer of 300 g per liter, both at room temperature, were supplied simultaneously. The zinc sulfate supply flow rate is 7.1 mL per minute and that of sodium zincate 5.1 mL per minute. The zinc sulfate is supplied at a constant flow rate to the surface of the suspension while the zincate is injected above the turbine. The flow rates mentioned above are controlled so as to maintain the pH of the suspension at 8. Neutralization was accomplished for a period of one hour and the suspension is then filtered on a 5 dm² Büchner filter. The thereby recovered solid phase was washed with demineralized water until a conductivity of 1 mS/cm is obtained and the cake was dried at 105° C. in a pulsed air oven.

The obtained cake had a thickness of 26 mm and a humidity 67.2%. The dried cake was then milled in a pin mill. The obtained product was then analyzed and the results are illustrated in the table.

TABLE

| | |
|---|---|
| Grain size d₅₀ (microns) | 2.05 |
| Grain size d₉₉ (microns) | 19.6 |
| Oil absorption (g per 100 g) | 69.8 |
| Loss at 105° C. (%) | 0.11 |
| Loss at 400° C. (%) | 4.48 |
| Loss at 800° C. (%) | 12.7 |
| ZnO (%) | 19.7 |
| Al₂O₃ (%) | 20.7 |
| SiO₂ (%) | 42.1 |
| BET (m² per g) | 28.2 |

It is well understood that the present invention is by no means limited to the embodiments described above and that many modifications may be made thereto without departing from the scope of the appended claims.

1. A crosslinking initiator comprising a mineral filler and zinc-bearing compound grafted on this mineral filler, in which said zinc-bearing compound is selected from the group consisting of zinc oxide, zinc hydroxide and mixtures thereof, the zinc-bearing compound being in the form of individual particles as rods with a nanometric size and the mineral filler in the form of grains having a grain size greater than that of the zinc-bearing compounds and in which the individual particles of the zinc-bearing compounds are grafted in a uniformly dispersed manner at the surface of said grains of the mineral filler.

2. The initiator according to claim 1, in which the mineral filler is selected from the group consisting of calcium carbonate, kaolin, silica, clay, talc, mica, carbon black and a mixture thereof.

3. The initiator according to claim 1, characterized in that the grafted particles do not cover the entirety of the surface of the mineral filler grains.

4. The initiator according to claim 1, in which the grafted zinc-bearing compound has an incorporation level comprised between 1 and 50% by weight based on the total weight of the initiator, preferably between 17 and 30% and more preferentially between 20 and 25%.

5. A method for manufacturing a crosslinking initiator according to claim 1, comprising:
dispersion of a mineral filler in an aqueous phase at a predetermined temperature with formation of an aqueous suspension,
circulation of this aqueous suspension along a controlled circuit,
introduction into the aqueous suspension of an aqueous solution of a base at a first end of said circuit,
simultaneously with said introduction, supply of an aqueous solution of a zinc salt to said aqueous suspension, at a second end of the circuit opposite to said first end, and
precipitation of a zinc-bearing compound selected from the group consisting of zinc oxide, zinc hydroxide and of their mixtures, which is grafted in a uniformly dispersed manner at the surface of said suspended mineral filler, the zinc-bearing compound being in the form of individual particles as rods with a nanometric size and the mineral filler in the form of grains having a grain size greater than that of the zinc-bearing compound.

6. The method according to claim 5, wherein said base is selected from the group consisting of a basic hydroxide, preferably NaOH or KOH, of a zincate, preferably sodium zincate, or of mixtures thereof.

7. The method according to claim 5, in which said zinc salt is selected from the group consisting of a zinc chloride, nitrate and sulfate.

8. The method according to claim 5, in which said predetermined temperature is comprised between room temperature and 95° C. and is preferably located around 50° C.

9. The method according to claim 5, further comprising recovery by filtration of the mineral filler on which is grafted the zinc-bearing compound and which is suspended in said aqueous phase.

10. The method according to claim 9, in which the filtration is followed by washing with water and optionally with drying,

11. The method according to claim 5, in which the simultaneous introduction and supply steps are accompanied by an increase in the circulation rate.

12. The method according to claim 5, in which the dispersion occurs in a reactor where the circulation is accomplished along a circuit between the surface of the suspension and the bottom of the reactor, said step for introducing the base occurring at the surface of the suspension and said step for supplying the zinc salt solution at the bottom of the reactor, or, conversely, said step for introducing the base occurring at the bottom of the reactor and said step for supplying the zinc salt solution at the surface of the suspension.

13. The method according to claim 5, in which the dispersion occurs in a reactor where the circulation is accomplished along a circuit arranged horizontally or obliquely between its two ends.
